(19) United States
(12) Patent Application Publication
(10) Pub. No.: US 2024/0067455 A1
(43) Pub. Date: Feb. 29, 2024

(54) PART REGISTRATION SYSTEM AND METHODS

(71) Applicants: Robert Schroeder, Fernandina Beach, FL (US); Jonathan Schroeder, South Beloit, IL (US); Derek Neises, Dekalb, IL (US); Beau Wileman, Raleigh, NC (US); Mythili Ananthula, Machesney Park, IL (US); Jackson Duncan, Janesville, WI (US); Yusif Barghouti Bahena, Downers Grove, IL (US)

(72) Inventors: Robert Schroeder, Fernandina Beach, FL (US); Jonathan Schroeder, South Beloit, IL (US); Derek Neises, Dekalb, IL (US); Beau Wileman, Raleigh, NC (US); Mythili Ananthula, Machesney Park, IL (US); Jackson Duncan, Janesville, WI (US); Yusif Barghouti Bahena, Downers Grove, IL (US)

(73) Assignee: Pacific Bearing Corp., Rockford, IL (US)

(21) Appl. No.: 18/504,755

(22) Filed: Nov. 8, 2023

Related U.S. Application Data
(63) Continuation of application No. PCT/US2022/027612, filed on May 4, 2022.
(60) Provisional application No. 63/187,219, filed on May 11, 2021.

(51) Int. Cl. B65G 43/00; B25J 11/00; B65G 65/00

(52) U.S. Cl. CPC B65G 43/00; B25J 11/00; B65G 65/005

(57) ABSTRACT

A part registration system for registering one or more parts relative to a robot having a robotic arm that defines a plane of optimal reach at a vertical position is provided. The part registration system includes a tray support rack, a tray support shelf and a tray transfer arrangement. The tray support rack is configured to support a plurality of trays for holding one or more parts. The tray support rack has a plurality of tray support regions in which one or more trays may be supported. The plurality of tray support regions are at different vertical positions. The tray support shelf is vertically adjustable relative to the tray support rack. The tray transfer arrangement transfers the trays between the tray support rack and the tray support shelf. Methods are also provided.

### CROSS-REFERENCE TO RELATED PATENT APPLICATIONS

This patent application is a continuation of co-pending International Application No. PCT/US2022/027612, filed May 4, 2022, and which designates the United States. The entire teachings and disclosure of International Application No. PCT/US2022/027612 are incorporated herein by reference thereto. International Application No. PCT/US2022/027612 claims the benefit of U.S. Provisional Patent Application No. 63/187,219, filed May 11, 2021, the entire teachings and disclosure of which are incorporated herein by reference thereto.

### FIELD OF THE INVENTION

This invention generally relates to systems and methods for registering parts relative to a robotic arm.

### BACKGROUND OF THE INVENTION

Robotic systems often process a plurality of different parts. Robots and cobots, by nature, outperform humans when it comes to strength, stamina, and repeatability/uniformity in motion. To perpetuate the continuous operation of the cobot/robot, in a machine tool or other automated setting, a system is needed to supply parts of varied shapes at point of use.

Robots are used to improve productivity while reducing fatigue of humans. Where there is a shortage of labor, weekend, second and third shift robots keep operations productive. It is estimated that for every 10 people that retire from manufacturing operations only 2 people are entering the workforce. Robots were thought to be the solution.

Current solutions require a human interface to supply parts to the robot loading area to keep it running. The robot has solved part of the problem, but a true 24 hr per day robot that is unattended by human intervention is not cost effective for the vast majority of robot installations.

To process the parts, the parts must be located within the reach of the robot, such as within the reach of a robotic arm of the robot. Robotic arms have a particular plane where their reach is optimized and can process a maximum of vertically oriented parts. Unfortunately, when parts are not located proximate this plane, fewer than an optimal amount of parts can be processed by the robot.

Systems currently on the market seek to supply the parts to the cobot/robot by providing a tray to contain the parts tended by the cobot/robot. The tray of parts is then located proximate the cobot/robot.

Current systems on the market require a human to position the parts in the loading area of the robot/cobot and then remove and replace the parts. This diminishes the effectiveness of the robot/cobot. If the parts could be continuously placed and replaced in the robot loading area, the process could continue in an untended operation 24 hrs per day.

Current systems do not allow the use of Automatic Guided Vehicles (AGV's) to move parts automatically to and from operations and then be recognized and loaded into the required process by a robot.

Another solution is using vision systems on the robots/cobots. This is both expensive and difficult to deploy. This requires engineers or highly trained robotic technicians to program and monitor.

However, the tray is typically located on a plane, such as a tabletop or work bench surface, which is not optimal for the reach of the cobot/robot. Automatic operation is limited to the number of parts the cobot/robot can reach. This problem is exacerbated when parts of varying height are tended by the same cobot/robot if the parts are all located in a common horizontal plane when they are accessed by the robot.

Further, in existing systems which organize several trays in vertical stacks, cobots/robots can only tend to parts which are exposed one layer at a time. These systems require the cobot/robot to move tray from load position to unload positions for continuous operations, resulting in the following limitations:
A.) Existing systems use a cobot/robot to pull a drawer out of a cabinet. A full dunnage tray may exceed the cobot/robot payload limit, limiting the number of parts per tray.
B.) The cobot/robot is on a fixed plane separate from that of the cabinet drawers. As described above, this limits the cobot/robot to only reach a small number of shelves, or it prevents access to the back corner of the trays where the shelves are not on the cobot's/robot's plane. The reduced reach limits the number of parts which can be stored on these trays, decreasing efficiency.
C.) The tray in the existing device is fixed to a drawer or a sliding drawer which must be moved out of the way in order to access a different drawer. In other words, the cobot/robot is prevented from delivering a part to another level on the same cart.
D.) These trays must be hand loaded by a human each time the tray is processed.

An additional problem with existing systems is that a motorized or manned rolling cart cannot be maneuvered to a cobot/robot with a varying tray height without an expensive vision system to detect the shelf plane. Tolerance stack-ups between a variety of carts presents a problem with consistent shelf planes.

To take full advantage of capital investments in these automated systems, such robots, the robot must be supplied a sufficient number of parts such that the automated system does not prematurely run out of parts before an operator can return to reload the automated system with parts. Thus, a system that can maximize the number of parts that can be registered relative to the robot in the system can maximize the operating time of the automated system.

Most material and part handling system solutions require quantities to be limited for the material to placed/removed in an ergonomic fashion. To stack large quantities, workers would need to grab and place materials at different levels.

Further, if changeover is required, a single rack on a machine can be time-consuming resulting in decreased efficiency.

These systems typically require material handling mechanisms that require an operator/worker to manually move the material/parts from one location to another. This transit costs labor time and can result in part damage or injury if not done safely.

Further, it is difficult to track material and parts within a facility. For many facilities, it is easy for material to be buried or lost in a cluttered area of the facility. This causes delays in production and labor time searching for lost or misplaced material.

Current systems use physical job packets to route material throughout a facility. These packets are easy to misplace or switch accidentally.

The present disclosure provides improvements in automated systems and particularly in systems for storing parts for use by a robot within a system as well as registering the parts relative to the robot to take full advantage of the operating parameters of the robot.

These and other advantages of the invention, as well as additional inventive features, will be apparent from the description of the invention provided herein.

### BRIEF SUMMARY OF THE INVENTION

In an example, a part registration system for registering one or more parts relative to a robot having a robotic arm that defines a plane of optimal reach at a vertical position is provided. The part registration system includes a tray support rack, a tray support shelf and a tray transfer arrangement. The tray support rack is configured to support a plurality of trays for holding one or more parts. The tray support rack has a plurality of tray support regions in which one or more trays may be supported. The plurality of tray support regions are at different vertical positions. The tray support shelf is vertically adjustable relative to the tray support rack. The tray transfer arrangement transfers the trays between the tray support rack and the tray support shelf.

In one example, a controller is configured to control the vertical position of the tray support shelf.

In one example, the controller is configured to control the vertical position of the tray support shelf to vertically locate one or more parts within a selected one of the trays such that the one or more parts is positioned vertically proximate the plane of optimal reach. The controller may use part dimensional information to determine where to vertically position the tray support shelf.

In one example, the controller is configured to control the vertical position of the tray support shelf to vertically locate the tray support shelf relative to the tray support rack to transfer a selected tray from the tray support rack onto the tray support shelf using the tray transfer arrangement and to transfer the selected tray from the tray support shelf to the tray support rack using the tray transfer arrangement.

In one example, the controller is configured to control actuation of the tray transfer arrangement.

In one example, the tray transfer arrangement is an actuator that is vertically positionable relative to the tray support rack to engage and actuate a selected one of the trays out of the tray support rack. That actuator may actuate generally horizontally to transfer the tray between the tray support rack and the tray support shelf.

In one example, the tray transfer arrangement is carried on or formed as part of the tray support shelf such that vertically positioning of the actuator is performed by vertically positioning the tray support shelf.

In one example, the tray support rack is an autonomous motorized cart that is independently movable relative to and dockable relative to the tray support shelf.

In one example, a tray vertical location sensor that communicates with the controller is provided. The controller uses information sensed by the tray vertical location sensor to control the vertical position of the tray support shelf relative to the trays within the tray support rack.

In one example, the sensor is a contact sensor that physically contacts the tray support rack or one or more of the trays stored therein.

In one example, at least one of the vertical positions at which a tray may be supported within the tray support rack is out of the vertical reach of the robotic arm of the robot.

In one example, one or more of the tray support regions hold trays out of the reach of the robotic arm of the robot.

In one example, the controller is configured to adjust the vertical position of a selected tray after a first part within the selected tray is processed by the robot and before a second part within the selected tray is processed by the robot.

In one example, the controller is operably configured to communicate with the robot.

In one example, the controller is configured to operably communicate with the tray support rack to obtain part dimensional information of parts carried by the tray support rack.

In an example, a method of positioning one or more parts to be processed by a robot relative to the robot is provided. The robot has a robot arm that has a plane of optimal reach. The method includes using a part registration system as outlined above. The method includes positioning the tray support shelf at a first vertical position for retrieving a selected tray from the tray support rack using the tray transfer arrangement. The method includes transferring the selected tray from the tray support rack to the tray support shelf. The method includes positioning the tray support shelf at a second vertical position, different than the first vertical position, at which parts within the selected tray are positioned proximate the plane of optimal reach.

In one example, the method further includes positioning the tray support shelf at a third vertical position for returning the selected tray to the tray support rack using the tray transfer arrangement. The method also includes transferring the selected tray from the tray support shelf to the tray support rack.

In one example, the first and third vertical positions are the same.

In one example, the method includes positioning the tray support shelf at a fourth vertical position different than the first vertical position. The method includes transferring a second selected tray from the tray support rack to the tray support shelf. The method includes positioning the tray support shelf at a fifth vertical position, different than the second vertical position. The method includes positioning the tray support shelf at a sixth vertical position for returning the second selected tray to the tray support rack using the tray transfer arrangement.

In one example, the step of transferring the selected tray from the tray support shelf to the tray support rack transfers the selected tray to the tray support rack when the tray has fewer parts than when the tray was transferred from the tray support rack to the tray support shelf.

In one example, the method includes sending a signal to the robot when the tray support shelf is in the second vertical position.

In one example, the step of transferring the selected tray from the tray support rack to the tray support shelf includes engaging the selected tray with the tray transfer arrangement and actuating the selected tray with the tray transfer arrangement from the tray support rack to the tray support shelf.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a robot and a part registration system according to an example of the disclosure;

FIG. 2 is a schematic representation of a plane of optimal reach of the robot of FIG. 1;

FIG. 3 is a perspective illustration of the part registration system of FIG. 1 utilizing an autonomous tray support rack;

FIG. 4 is a plan view of the robot and part registration system of FIG. 1 with a first tray of parts positioned proximate the plane of optimal reach of the robot of FIG. 1;

FIG. 5 is a plan view of the robot and part registration system of FIG. 1 with a second tray of parts positioned proximate the plane of optimal reach of the robot of FIG. 1; and

FIG. 6 is a further perspective illustration of the robot and part registration system of FIG. 1 with a tray at a different vertical position being loaded on to the shelf of the part registration system.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

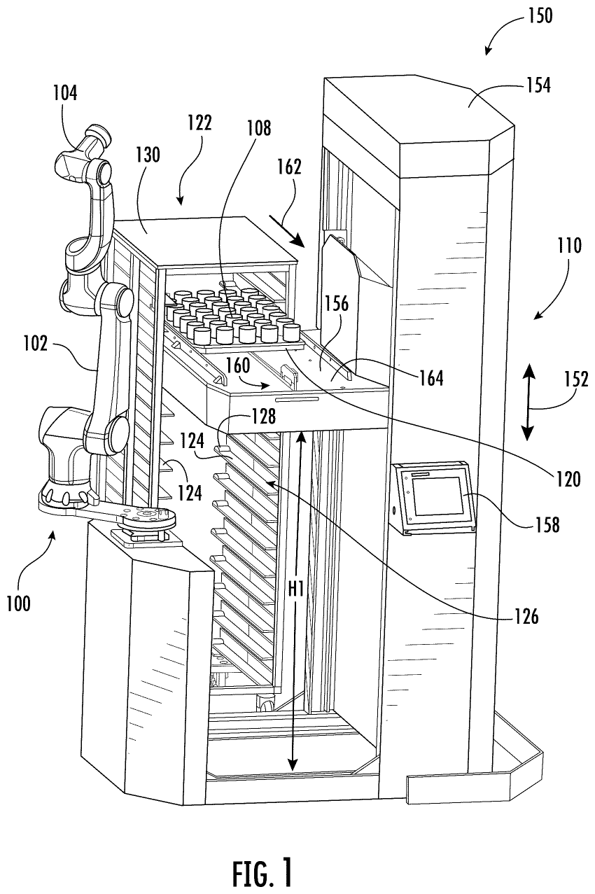

FIG. 1 illustrates a robot 100 (also referred to as a cobot/robot—the term “robot” shall be broad enough to include any combination of robot, cobot and/or robot/cobot unless expressly limited to one of these alternative terms) having a robotic arm 102 and end effector 104 proximate a part registration system 110 that registers parts 108 to be manipulated by the robot 100 and particularly the end effector 104 thereof.

In one example, the robot 100 and particularly the end effector 104 thereof is configured to grab individual or multiple ones of the parts 108 and place them in a separate machine where subsequent operations are performed on the parts 108. For example, the robot 100 may place the parts 108 in a CNC machine for machining of the parts 108.

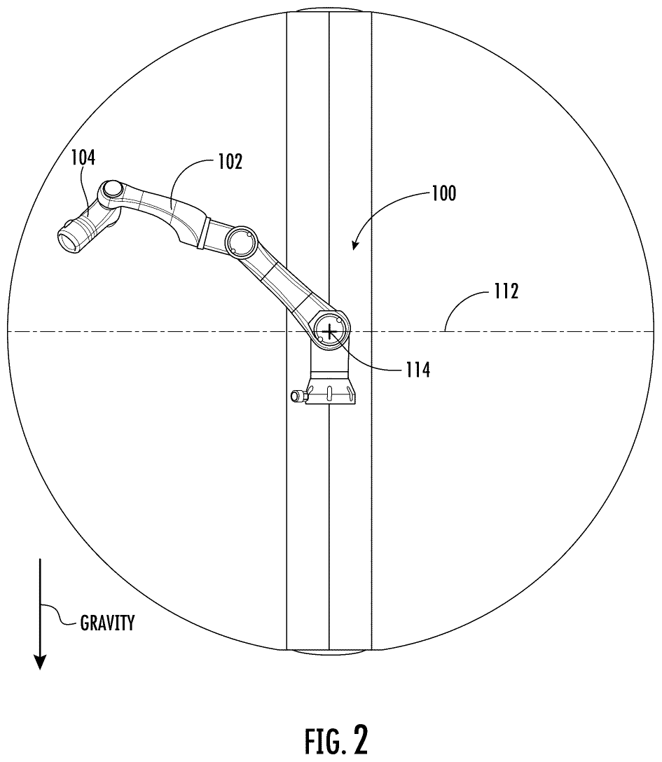

With reference to FIG. 2, the robot 100 and particularly the robotic arm 102 thereof has a plane of optimal reach 112 that maximizes the amount of surface area that parts may be located in and still be properly manipulated (typically grabbed) by the end effector 104. Typically, the plane of optimal reach 112 will pass through or be closely adjacent a pivot axis 114 remote from end effector 104.

The plane of optimal reach 112 in this example is orthogonal to gravity as all parts 108 to be manipulated by the robot 100 are simply resting on corresponding trays 120. The plane of optimal reach 112 is at a particular vertical position. The optimal reach of the robot 100 is when the robotic arm 102 is fully extended.

The part registration system 110 registers the parts 108 relative to the robot 100 to maximizes the number of parts 108 that can be manipulated by the robot 100. This is done by best positioning the parts 108 relative to the plane of optimal reach 112. The part registration system 110 is flexible in that it can accommodate parts of different sizes (particularly vertical heights) and sizes while adjusting the vertical position of the parts relative to the robotic arm 102 so that the relevant portion of the different parts 108 is positioned within the plane of optimal reach 112.

The part registration system 110 includes a tray support rack 122 that can store a plurality of trays 120 that are filled with one or more parts 108. The tray support rack 122 includes a plurality of vertically arranged tray support regions 126 in which the trays 120 are supported. The trays 120 are slidably supported by tray supports 124 that allow the trays 120 to be slid into and out of the tray support rack 122. Each set of tray supports 124 defines a separate tray support region 126. Thus, the illustrate tray support rack 122 can store a plurality of trays 120 in a vertical spaced orientation.

In the illustrated example, each tray support region 126 includes a tray stop 128 that properly locates the trays 120 within the tray support region 126 on tray supports 124.

In the example of FIG. 1, the tray support rack 122 would typically be moved by an operator. In some examples, this tray support rack 122 could be guided by a vehicle. The vehicle could be directly controlled by a user, such as in the form of a tractor, or could be in the form of an autonomous guided vehicle (AGV) robot.

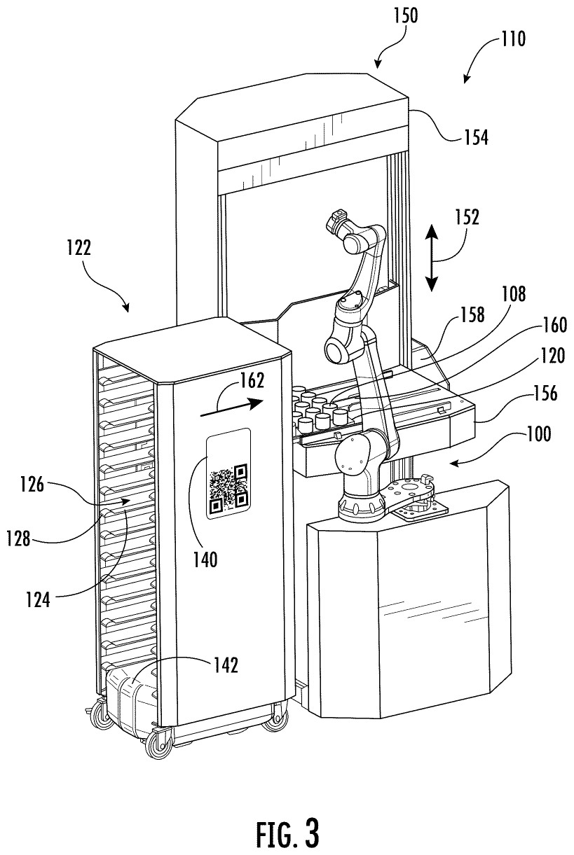

In some embodiments and with reference to FIG. 3, the tray support rack 122 is incorporated into an autonomous motorized cart. In such an arrangement, the tray support rack is independently movable without requiring a user to manually push the cart relative to the robot 100. A controller 140 of the tray support track 122 can control motor 142 to autonomously drive the tray support track 122. For instance, the tray support track 122 can be autonomously driven to a source of parts 108 when all parts have been removed or otherwise manipulated by robot 108 so that the tray support track 122 can be loaded with more parts 108 without requiring intervention by a human operator.

In other examples, the tray support rack could be a permanent component of the tray support shelf 150. The tray support shelf 150 is more fully described below.

In addition to the tray support rack 122, the part registration system 110 includes a tray support shelf 150 that is vertically adjustable, illustrated by arrow 152, relative to the tray support rack 122 as well as the robot 100. This allows the tray support shelf 150 to access trays 120 within different vertically positioned tray support regions 126 of the tray support rack 122 that are above or below the plane of optimal reach 112 as well as allows parts of different sizes, such as different heights, to be positioned at an optimal vertical position relative to the robot 100 so that the maximum amount of the plan of optimal reach 112 is filled with parts 108.

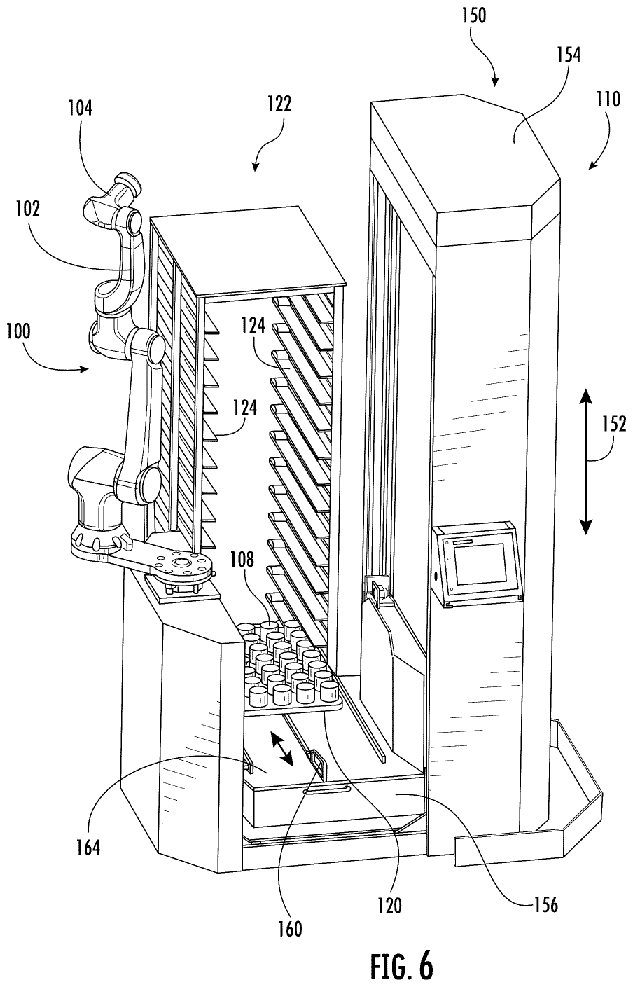

FIG. 1 illustrates the system accessing a tray 120 that is above the plane of optimal reach 112 while FIG. 6 illustrates the system accessing a tray 120 that is below the plane of optimal reach 112.

The tray support shelf 150 is in the form of an elevator that includes a support structure 154 that carries shelf 156. Shelf 156 is vertically adjustable relative to support structure 154. The tray support shelf 150 may include actuation mechanisms such as linear actuators (e.g. hydraulic or pneumatic pistons, lead or ball screws, etc) or chains, belts or pulley systems for vertically moving the shelf 156 up and down.

The tray support shelf 150 includes a controller 158 for controlling the operations of the tray support shelf 150, such as vertical positioning of the shelf 156.

The part registration system 110 further includes a tray transfer arrangement 160 for transferring trays 120 between the tray support rack 122 and the tray support shelf 150. In this example, the tray transfer arrangement is a hook member that hooks a desired tray 120 and drags a selected tray 120 from the tray support rack 122 onto shelf 156 or pushes the tray 120 from the shelf 156 into tray support rack 122.

The tray transfer arrangement 160 may include an actuator such as a linear actuator for translating the hook member thereof. The tray transfer arrangement 160 may also include one or more linear slide or one or more linear stage.

In this example, the tray transfer arrangement 160 is carried by and built into shelf 156. In such an embodiment, the tray transfer arrangement 160 is vertically positionable relative to the selected tray 120 by vertically positioning the shelf 156. In this example, the hook member of the tray transfer arrangement 160 that engages the trays 102 extends through a slot formed on the tray support surface of the shelf 156.

In other embodiments, the tray transfer arrangement 160 could be built into the tray support rack 122. For example, the tray supports 124 could be actuatable to transfer a selected tray 120 between the tray support rack 122 and the shelf 156. Further yet, in some embodiments, the robot 100 itself could be used as the tray transfer arrangement.

In operation, the shelf 156 is vertically oriented relative to a tray support region 126 holding a selected tray 120. A tray vertical location sensor, such as a contact sensor, proximity sensor, optical sensor or other sensor can indicate when the shelf 156 is at the correct vertical position relative to the tray support rack 122 and the selected tray 120. This first vertical position is represented by height H1 in FIG. 1. A particular contact sensor may directly contact the trays or representative features of a tray formed as part of the tray support rack 122.

When the shelf 156 is in the proper vertical position, the tray transfer arrangement 160 operably transfers the selected tray 120 to the shelf 156. Arrow 162 in FIGS. 1 and 3 represent the desired tray 120 being transferred from the tray support rack 122 to shelf 156.

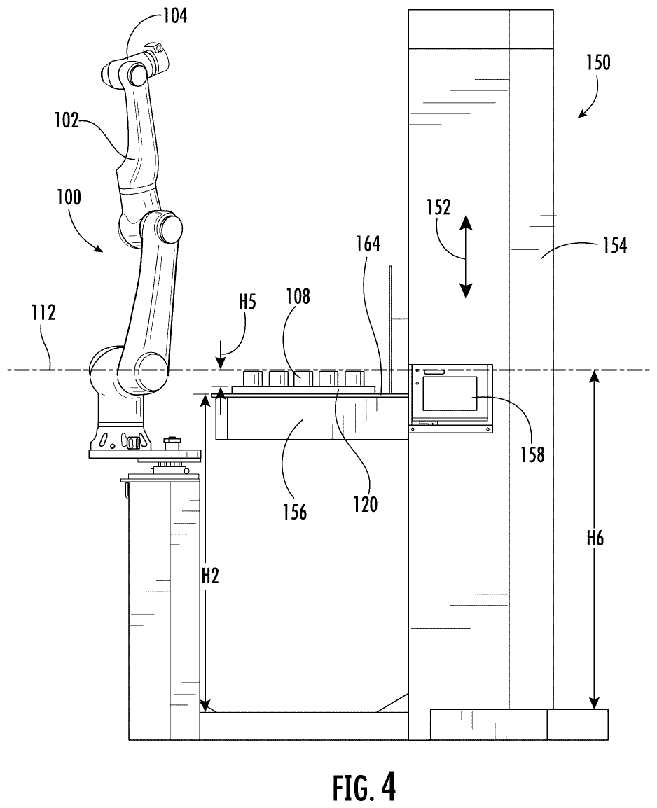

Thereafter, the shelf 156 is translated, if necessary, to a second vertical position relative to the robot 100. In particular, the shelf 156 is transitioned to a second vertical position that places the relevant portion of the parts 108 carried on the selected tray 120 within the plane of optimal reach 112 of the robot 100. FIG. 4 illustrates the shelf 156 at the second vertical position with parts 108 located with the tops thereof (the relevant portion of the parts 108) within the plan of optimal reach 112. This second vertical position is represented by height H2 in FIG. 4.

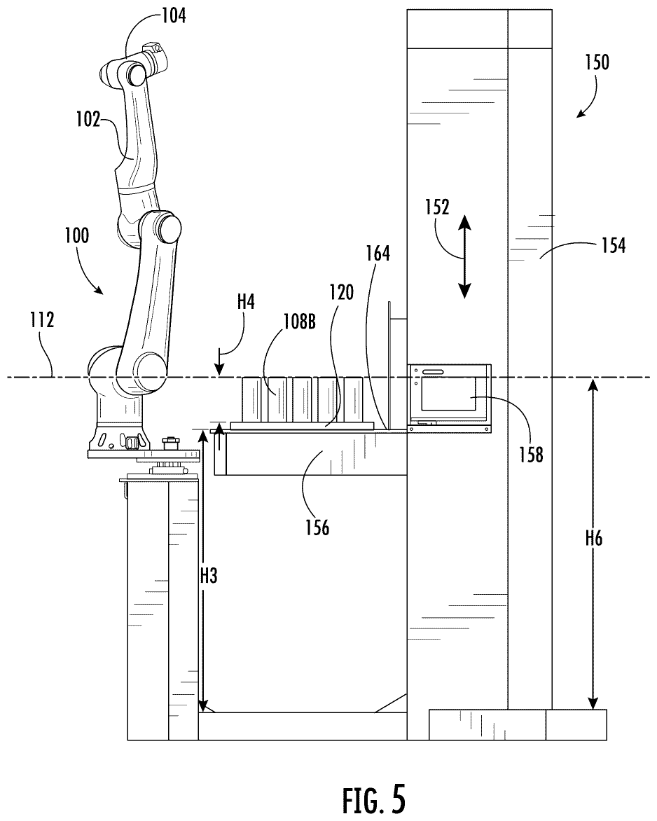

FIG. 5 illustrates the shelf 156 at a third vertical position represented by a height H3. Height H3 is used in this example because the parts 108B have a different height H4 than the height H5 of the parts in FIG. 4. More particularly, parts 108 of FIG. 4 have a height H5 that is shorter than the height H4 of parts 108B in FIG. 5. Thus, to have the top ends of the parts 108, 108B both at the plane of optimal reach 112, tray 120 in FIG. 5 must be vertically lower than in FIG. 4.

Thus, it can be seen that the tray support shelf 150 and its vertically adjustable shelf 156 provides a support surface 164 that is vertically adjustable to compensate for different height parts 108, 108B.

Notably, the plane of optimal reach 112 is at the same vertical height H6 in both FIGS. 4 and 5.

Once all of the parts 108 have been processed by robot 100, the shelf 156 will return the spent tray 120 (and any parts that may have been returned thereto) to the corresponding tray support region 126 and a new tray 120 in a different tray support region 126 may be selected.

This process can be repeated until all parts 108 have been processed. Thereafter, the tray support rack 122 can be refilled with new trays 120 that have unprocessed parts 108. A separate tray support rack 122 may be provided that can be docked relative to the robot 100 and the tray support shelf 150 while the prior tray support rack 122 is being refilled. This is particularly beneficial when autonomous motorized tray support racks 122 are used. One rack 122 can be filled while the other is being used to supply parts 108 to the robot 100. The system can be configured that the autonomous motorized tray support racks 122 can move between the location of the robot 100/tray support shelf 150 and the location of reloading without a human operator required to push the tray support racks 122.

FIG. 6 illustrates a further tray 120 being loaded onto shelf 156. This tray 120 is positioned proximate a vertical bottom of the tray support rack 122. By using the vertically adjustable shelf 156, the tray support rack 122 can carry trays 120 at vertical positions that would otherwise be out of the reach of the robotic arm 102 of the robot 100. Here, the shelf 156 transitions the tray 120 from the unreachable location to a reachable location and preferably a vertical location where the parts are proximate the plane of optimal reach 112.

Controller 158 can be configured to control robot 100 or a separate controller for the robot 100 may be provided that communicates with controller 158. Controller 158 will use information related to what parts 108 are stored on what trays 120 within predetermined tray support regions 126. One particularly piece of information is the vertical height at which the tray 120 needs to be positioned relative to robot 100 so that the parts 108 are located within or proximate the plane of optimal reach 112. Again, this can vary depending on the configuration of the individual parts 108.

Notably, in some instances, parts 108 on a single tray 120 can have different vertical heights and controller 158 can adjust the vertical position of the shelf 156 in between processing activities of the robot 100 depending on the height of the part 108 that is going to be processed by the end effector 104 of the robot 100.

In some embodiments, the tray support rack 122 stores part information related to the parts 108 carried thereby, such as part dimensional information that is used by controller 158 to vertically position the parts 108 relative to the plane of optimal reach 112. This could be communicated wirelessly or through wires to controller 158. This could be done using Wi-Fi, Bluetooth, Ethernet, Near Field Communication, RFID, bar code, or other known communication protocols.

As illustrated in FIG. 3, tray support rack 122 includes a display, which may be part of or separate from controller 140. The display is currently displaying a QR code that can be scanned that provides the part dimensional information or directs controller 158 to a location where the relevant part dimensional information is stored. The display can be used to further display useful information about the parts 108 on the trays 120 within the tray support rack 122.

The tray support rack 122 in FIG. 3 can be automatically guided, tracked and routed via resource management software.

The use of the autonomous tray support rack allows the tray support rack 122 to be loaded and unloaded with programmable cobots/robots for operator safety and for run time during reduced onsite personnel. The autonomos tray support rack 122 is also dockable with the tray support shelf 150 for part/job information transfer. Further, the display, e.g. the display that is displaying the QR code in FIG. 3, can be an electronic display that is always on and displays the job information for quick robot 100 programming.

It can be appreciated that by providing the adjustable shelf 156 the parts within tray 120 can be brought to the optimal vertical location for processing by robot 100. Thus, the tray 120 can be optimized to hold the optimal number of parts that can be reached by the robot while also solving the problem of parts having varying heights.

Further, the adjustable shelf 156 can retrieve trays from an infinite number of shelf storage regions. The sensor can be used to easily locate the particular height of a selected shelf storage region.

While the present figures generally show a single tray 120 at a time for simplicity of explanation, typically, multiple trays 120 filled with parts 108 would be used.

In some examples, the trays contain an active or passive communication device or marking which allows the system to determine information about the parts contained on the tray. This could be done using Wi-Fi, Bluetooth, Ethernet, Near Field Communication, RFID, bar code, QR code, or other known communication protocols.

In some examples, each tray contains an active or passive communication device or marking which creates a unique identifier for each tray. This could be done using Wi-Fi, Bluetooth, Ethernet, Near Field Communication, RFID, bar code, QR code, or other known communication protocols. The unique identifier could then otherwise be tied to or used to obtain part specific information for the parts stored on the particular tray.

In some examples, the system includes a plurality of tray support racks. Each tray support rack contains an active or passive communication device or marking which creates a unique identifier. This unique identifier can be used to track the tray support rack and/or communicate the contents stored therein. This could be done using Wi-Fi, Bluetooth, Ethernet, Near Field Communication, RFID, bar code, QR code, or other known communication protocols.

In some examples, multiple tray support shelves may be provided. Each tray support shelf would be configured to vertically position components thereon proximate to the plane of optimal reach of one or more associated robots.

In some examples, the tray support rack contains an active or passive communication device which allows the tray support rack to communicate with the facility or Autonomous Guided Vehicles (AGV's), including, but not limited to location or triangulation within the facility. This could be done using Wi-Fi, Bluetooth, Ethernet, Near Field Communication, RFID, bar code, QR code, or other known communication protocols. This can allow for autonomous motion of the tray support rack and/or an AGV coupled to the tray support rack for autonomous motion of the tray support rack within a facility.

In some examples, the support structure of the tray support shelf contains a visual display that may be separate or part of the controller thereof that can be used to display information, including but not limited to information about the parts being processed, system status or can be connected to a camera to display the inside of a connected machine (e.g. a CNC machine that has an opaque cover).

In some examples, the controller of the tray support shelf can communicate, wired or wirelessly, with a CNC machine, grinder, painter, deburrer, press, welder or other equipment and control actuation of the robot or part registration system.

In some examples, the tray support rack has a visual display system (TV) which will display useful information (e.g. part number, quantity, job number, next machine operation/location) to users.

In some examples, the tray support rack contains a single or plurality of trays which contain jigs, fixture, tooling, inspection equipment, etc. necessary for the operation of the machine or work center. The tray support rack can be used for only tooling or for a combination of tooling and parts.

In some examples, the controller of the tray support rack may be configured to control, store and/or display information about the status or contents of the tray support rack, including but not limited to: the origin and/or destination; job, operation or process number and information; pictures; part numbers and descriptions; cost; age, etc. This information can be viewed on a display mounted on the tray support rack or through a wired or wireless network.

In some examples, the controller of the tray support rack is configured to illuminate a light, sound or vibratory device intended to call attention to the specific tray support rack so that an operator can easily find it, know that it needs attention or know that is ready to be moved.

In some examples, the controller of the tray support rack is configured to communicate with an Autonomous Guided Vehicle (AGV) so that the AGV knows where the tray support rack is located, the orientation necessary for docking and where it needs to travel to. The AGV can then autonomously travel to and/or with the tray support rack.

In some examples, the tray support rack includes a moving carousel. The tray supports are part of the carousel such that the position of the tray support regions are not fixed relative to a frame of the tray support rack.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A part registration system for registering one or more parts relative to a robot having a robotic arm that defines a plane of optimal reach at a vertical position, the part registration system comprising:
a tray support rack configured to support a plurality of trays for holding one or more parts, the tray support rack having a plurality of tray support regions in which one or more trays is supported, the plurality of tray support regions being at different vertical positions;
a tray support shelf that is vertically adjustable relative to the tray support rack; and
a tray transfer arrangement for transferring the trays between the tray support rack and the tray support shelf.

2. The part registration system of claim 1, further comprising a controller configured to control the vertical position of the tray support shelf.

3. The part registration system of claim 2, wherein the controller is configured to control the vertical position of the tray support shelf to vertically locate one or more parts within a selected one of the trays such that the one or more parts is positioned vertically proximate the plane of optimal reach.

4. The part registration system of claim 2, wherein the controller is configured to control the vertical position of the tray support shelf to vertically locate the tray support shelf relative to the tray support rack to transfer a selected tray from the tray support rack onto the tray support shelf using the tray transfer arrangement and to transfer the selected tray from the tray support shelf to the tray support rack using the tray transfer arrangement.

5. The part registration system of claim 1, wherein the tray transfer arrangement is an actuator that is vertically positionable relative to the tray support rack to engage and actuate a selected one of the trays out of the tray support rack.

6. The part registration system of claim 5, wherein the tray transfer arrangement is carried on or formed as part of the tray support shelf such that vertically positioning of the actuator is performed by vertically positioning the tray support shelf.

7. (canceled)

8. The part registration system of claim 1, wherein the tray support rack is a cart that requires direct manual manipulation by an operator to move the tray support relative to the tray support shelf and to dock the tray support rack with the tray support shelf.

9. (canceled)

10. The part registration system of claim 1, wherein the tray support rack and tray support shelf are formed as a single unitary unit, the tray support shelf being vertically movable relative to the tray support rack in operation but the tray support rack is prevented from being removed from the tray support shelf.

11. The part registration system of claim 4, further comprising a tray vertical location sensor that communicates with the controller, the controller using information sensed by the tray vertical location sensor to control the vertical position of the tray support shelf relative to the trays within the tray support rack.

12-14. (canceled)

15. The part registration system of claim 2, wherein the controller is configured to adjust the vertical position of a selected tray after a first part within the selected tray is processed by the robot and before a second part within the selected tray is processed by the robot.

16. (canceled)

17. The part registration system of claim 2, wherein the controller is configured to operably communicate with the tray support rack to obtain part dimensional information of parts carried by the tray support rack.

18-20. (canceled)

21. The part registration system of claim 1 further comprising a plurality of tray support shelves; and
wherein a first one of the tray support shelves cooperates with a first tray support rack and a second one of the tray support shelves cooperates with a second tray support rack, unprocessed parts would be supplied by the first tray support rack and transferred to the first tray support shelf, after processing, the finished part would be loaded onto a tray supported by the second tray support shelf and then the tray supported by the second tray support shelf would be transferred to the second tray support rack.

22-23. (canceled)

24. The part registration system of claim 1, wherein the tray support shelf includes a shelf and a support structure, the shelf being movable vertically relative to the support structure, the support structure includes a visual display that can be used to display information.

25. The part registration system of claim 2, wherein the controller can communicate, wired or wirelessly, with a CNC machine, grinder, painter, deburrer, press, welder or other equipment and cause the robot or part registration system to actuate.

26-31. (canceled)

32. A method of positioning one or more parts to be processed by a robot relative to the robot, the robot having a robot arm that has plane of optimal reach, the method comprising:
using a part registration system of claim 1:
positioning the tray support shelf at a first vertical position for retrieving a selected tray from the tray support rack using the tray transfer arrangement;
transferring the selected tray from the tray support rack to the tray support shelf; and
positioning the tray support shelf at a second vertical position, different than the first vertical position, at which parts within the selected tray are positioned proximate the plane of optimal reach.

33. The method of claim 32, further comprising:
positioning the tray support shelf at a third vertical position for returning the selected tray to the tray support rack using the tray transfer arrangement; and
transferring the selected tray from the tray support shelf to the tray support rack.

34. The method of claim 33, wherein the first and third vertical positions are the same.

35. The method of claim 32, further comprising:
positioning the tray support shelf at a fourth vertical position different than the first vertical position;
transferring a second selected tray from the tray support rack to the tray support shelf;
positioning the tray support shelf at a fifth vertical position, different than the second vertical position.

36-37. (canceled)

38. The method of claim 32, further comprising sending a signal to the robot when the tray support shelf is in the second vertical position.

39. The method of claim 32, wherein the step of transferring the selected tray from the tray support rack to the tray support shelf includes engaging the selected tray with the tray transfer arrangement and actuating the selected tray with the tray transfer arrangement from the tray support rack to the tray support shelf.
